(19) United States
(12) Patent Application Publication
(10) Pub. No.: US 2025/0015688 A1
(43) Pub. Date: Jan. 9, 2025

(54) METHOD FOR INSERTING AND ASSEMBLY FOR TRANSFERRING CONDUCTIVE PINS FOR A ROTARY ELECTRIC MACHINE

(71) Applicant: VALEO EQUIPEMENTS ELECTRIQUES MOTEUR, Creteil Cedex (FR)

(72) Inventors: Stéphane DE CLERCQ, Etaples-sur-Mer (FR); Jean DUQUESNE, Etaples-sur-Mer (FR); Humberto TELES DE MENEZES, Etaples-sur-Mer (FR); Ludovic DARRAS, Etaples-sur-Mer (FR); Samuel GRESSIER, Etaples-sur-Mer (FR); Hassna ACHIBANE, Etaples-sur-Mer (FR); Vincent RAMET, Etaples-sur-Mer (FR)

(73) Assignee: VALEO EQUIPEMENTS ELECTRIQUES MOTEUR, Creteil Cedex (FR)

(21) Appl. No.: 18/684,099

(22) PCT Filed: Jul. 29, 2022
(86) PCT No.: PCT/EP2022/071444

§ 371 Date: Feb. 15, 2024

(30) Foreign Application Priority Data
Aug. 24, 2021 (FR) FR2108849

(51) Int. Cl. H02K 15/06; H02K 15/02

(52) U.S. Cl. CPC H02K 15/064; H02K 15/026; H02K 2215/00

(57) ABSTRACT

A method for inserting conductive pins from a transfer device to a body of a wound part in order to form an electrical winding of a wound part of a rotary electric machine. The method includes a preparation step, in which the conductive pins are arranged in the spindle body, and a step of positioning the spindle body relative to the body of the wound part. A guide step arranges a guide device to guide the conductive segments in a circumferential and/or radial direction, and a transfer step inserts conductive segments into the corresponding slots.

The invention notably relates to a method for inserting conductive pins from a transfer device to a body of the wound part of a rotary electric machine and an assembly for transferring conductive pins allowing said method to be implemented.

The invention is particularly advantageously applicable in the field of rotary electric machines such as alternators, starter-alternators, or even reversible machines or electric motors. By way of a reminder, a reversible machine is a rotary electric machine that is able to operate reversibly, on the one hand, as an electric generator when functioning as an alternator and, on the other hand, as an electric motor.

A rotary electric machine comprises a rotor that is free to rotate about an axis, and a fixed stator. In alternator mode, when the rotor is rotating, it induces a magnetic field on the stator, which converts it into electric current in order to supply power to the electrical consumers of the vehicle and to recharge the battery. In motor mode, the stator is electrically powered and induces a magnetic field causing the rotor to rotate, for example, in order to start the heat engine of the vehicle, such as a motor vehicle, or to provide torque assistance thereto.

A wound part of a rotary electric machine is, for example, a stator comprising a body of the wound part having a yoke forming a part for rotating about an axis passing through the center of the stator. The body comprises teeth radially extending from the yoke toward the center of the stator and around which an electrical winding is disposed. More specifically, the teeth together define slots, through which conductive elements pass that are involved in forming the winding of the stator. The winding in this case is formed by a plurality of conductive pins partially housed in the slots of the body and electrically connected in pairs via their ends in order to form a continuous electrical path. Most conductive pins comprise two conductive segments substantially parallel to one another and connected by an elbow joint so as to form an offset “U”. The conductive segments are respectively inserted, at a first axial end face of the stator, into two distinct slots so that the elbow joints are protruding from the first axial end face of the stator.

This offset “U” shape of the pins is conventionally obtained by a first folding step that allows a flat “U” shape to be obtained, in which shape the two conductive segments extend in the same plane, then by a second twisting step, in which the two conductive segments are offset in a circumferential direction relative to one another. This twisting step is conventionally carried out during an overall twisting step, during which all the conductive pins are twisted at the same time in order to obtain the offset for their respective conductive segments. This overall twisting step allows the pins to be positioned on a circle of diameter corresponding to their final position in the body of the wound part. A tool such as a clamp then allows all the pins placed in the twisting tool to be recovered and allows them to be inserted into the body of the wound part. The overall twisting step facilitates the operation of transferring the pins from the twisting tool to the body of the wound part since once the pins have been twisted they are already disposed in their final position, corresponding to the correct diameter of the stator, allowing them to be directly inserted into said body. However, this overall twisting step does not allow precise twisting of the pins and can generate breaks in the enamel covering the copper forming the conductive pins, which can cause short-circuits.

The twisting step alternatively can be carried out by a single twisting step, in which each pin is individually twisted, which allows the final dimensions of the pins to be better controlled and any breakages of the enamel to be avoided. Due to their “U” shape and the offset between the conductive segments, it is not possible, during an automatic method, to position the pins directly in their final position so that they can be inserted into the body of the wound part. For example, a known method involves placing the pins in a tool with a diameter that is significantly greater than the diameter of the body of the wound part in order to subsequently advance the pins in a radial direction toward the axis of the tool, until the pins are placed in their final position for insertion into the body of the wound part. A clamp, such as those used after an overall twisting method, then can be used to transfer the pins from this tool to the body of the wound part.

These various steps of placing the pins in a diameter corresponding to the diameter of their final position in the body of the wound part, as well as transferring the pins from the tool for placing them in said body, are generally carried out using several tools, which makes the method for producing the winding of the wound part more complex, lengthens the manufacturing time on the assembly lines by transferring the pins between the various tools and can increase the risk of failure of one of the tools. These two disadvantages increase the cost of manufacturing a wound part comprising a winding of the conductive pin type.

The aim of the present invention is to avoid the disadvantages of the prior art. To this end, the aim of the present invention is a method for inserting conductive pins from a transfer device to a body of a wound part, each conductive pin being formed by at least one conductive segment and being intended to be electrically connected to at least one other conductive pin via their free end in order to form an electrical winding of a wound part of a rotary electric machine extending around a first axis. According to the invention, the transfer device comprises a spindle body extending around a second axis and a plurality of guide strips radially extending from the spindle body, with lateral spaces intended to house at least one conductive segment being defined between two adjacent guide strips. According to the invention, the wound part comprises a cylindrical shaped body and a plurality of teeth extending from said body of the wound part so as to define slots between two adjacent teeth, which slots are intended to house at least one conductive segment. According to the invention, the insertion method comprises: a preparation step, in which the conductive pins are at least partially arranged in the lateral spaces of the spindle body of the transfer device; a step of positioning the spindle body of the transfer device relative to the body of the wound part so that they are axially positioned one above the other; a guide step, in which a guide device is arranged to guide the conductive segments of said conductive pins in a circumferential and/or radial direction; and a transfer step comprising a transfer phase, in which the conductive segments are inserted into the corresponding slots in an axial direction, and a phase of moving at least one guide strip between an engagement position, in which at least one portion of said strip extends between two conductive segments, and a disengagement position, in which said at least one portion of the strip extends away from said two conductive segments.

By virtue of the present invention, the transfer device equally allows the conductive pins to be arranged according to their final arrangement, i.e., the pins are arranged according to the diameter of the slots of the body of the wound part, and allows said pins to be inserted into the body of the wound part. Thus, a single device is used and the use of a transfer clamp is not necessary. The method for assembling the winding comprising conductive pins is simplified and shortened, the risks of incorrect positioning of the pins are reduced and the overall cost of the method for inserting the pins into the body of the wound part is decreased.

Furthermore, the guide step improves the guidance of the conductive pins toward the slots in order to prevent the conductive pins from coming into contact with the body of the wound part.

According to one embodiment, during the preparation step, the conductive pins are sequentially arranged in the lateral spaces. The term “sequentially” is understood to mean the fact that the pins are arranged individually or in groups of several pins in the lateral spaces and not all in one step. In other words, the preparation step comprises several successive insertion phases.

According to one embodiment, during the positioning step, the spindle body and the body of the wound part are arranged such that each lateral space is at least partially axially aligned with a corresponding slot of the body of the wound part.

According to one embodiment, the guide device comprises rods radially inserted between the conductive segments, with the guide step being carried out by moving said rods and/or the spindle body in a circumferential and/or radial direction. This simply improves the guidance of the pins.

According to one embodiment, the guide step comprises a phase of inserting at least one portion of the guide device between conductive segments in an insertion position, and a smoothing phase, in which the guide device and/or the transfer device is/are axially moved between the insertion position and a guide position, in which said portion of the guide device is arranged closer to the ends of said conductive segments relative to the insertion position. Separating the guide step into two steps allows said step to be simplified by allowing the guide device to be inserted into a favorable position where the pins are better spaced apart and/or better retained in position. This also allows, by virtue of the smoothing phase, the guide device to be brought closer to the ends of the pins in order to optimize their guidance and facilitate their insertion into the body of the wound part.

According to one embodiment, the rods of the guide device are radially inserted between the conductive segments and experience an axial translation movement during the smoothing phase in order to accompany the insertion of the conductive segments into the associated slots. The axial translation movement of the rods is notably stopped when the rods come into contact with the body of the wound part. This allows the guidance and the accompaniment of the conductive pins to be optimized.

Alternatively, the rods of the guide device can be positioned on the teeth of the body of the wound part during the insertion phase. The rods then do not experience an axial movement, thereby simplifying the manufacture thereof.

According to one embodiment, the rods of the guide device experience a radial translation movement. This movement allows the rods to be inserted between the conductive segments in order to allow them to be guided or removed once the guidance is complete.

According to one embodiment, the conductive segments are axially inserted into the slots, during the transfer step, up to their respective final axial position in the body of the wound part. This final axial position is obtained, for example, when part of each inserted conductive pin is in axial abutment with the body of the wound part. For example, the contact between a portion of each pin and said body can be direct or indirect and notably can be via an intermediate protective element axially arranged at the end of each tooth of said body or via an electrical insulator.

According to one embodiment, the body of the wound part has an annular shape extending around the first axis and the spindle body has a cylindrical shape extending around the second axis matching said annular shape such that, during the transfer step, the spindle body is inserted into the body of the wound part. Inserting the spindle body into the body of the wound part provides better stability for the conductive pins during the transfer step.

According to one embodiment, the pins are arranged in the spindle body with a diameter that is substantially equal to the diameter in which said pins will be arranged in the body of the wound part. In other words, only small radial movements of the pins are possible, notably during the guidance and/or transfer steps, for example, in order to compensate for the assembly clearances of the pins.

According to one embodiment, the spindle body further comprises at least one protuberance that at least partially inserts into a slot so as to circumferentially align the body of the wound part relative to the spindle body.

According to one embodiment, the transfer step further comprises a phase of removing a radial retention support that is arranged to retain the conductive segments of the conductive pins in the lateral spaces of the spindle body in a radial direction. This step of removing the retention support during the transfer step prevents the retention support from hindering the insertion of the conductive segments into the slots, while radially retaining the pins for as long as possible, in order to prevent an offset movement that would hinder the transfer step.

According to one embodiment, the removal phase has a first phase, in which the radial retention support is axially offset in an opposite direction to the transfer direction of the conductive pins, and then a second phase, in which the retention support is remote, notably radially remote, from the conductive pins. These two phases of the removal step optimize the radial retention of the conductive pins when they are transferred to the body of the wound part.

According to one embodiment, the transfer step further comprises a phase involving an axial retention support retaining the conductive pins in an axial direction in order to prevent an axial movement of said pins relative to the spindle body. This retention step optimizes the transfer of the conductive pins in the body of the wound part, while allowing homogeneous transfer of all the pins at the same time. This optimizes the time for carrying out said step.

According to one embodiment, the transfer step further comprises a phase of blocking the conductive pins in a radial direction, using a blocking device, so as to prevent a radial movement of said pins relative to the body of the wound part. For example, the blocking phase is carried out so as to prevent a radial movement toward the outside relative to the axis of the body of the wound part.

“Radial direction toward the outside relative to an axis” is understood to mean a radial direction in the opposite direction to said axis.

According to one embodiment, the transfer step can further comprise a phase of thrusting the conductive pins in a radial direction using a thrust device. This prevents the conductive pins from coming into contact with the body of the wound part and thus better guarantees their insertion into said body. For example, the thrust phase is carried out in a radial direction toward the outside relative to the axis of the body of the wound part, so as to prevent contact between said pins and the internal end of said body, notably the tooth roots.

According to one embodiment, the guide strips are retractable so as to be able to be respectively housed in corresponding grooves produced in the spindle body, during the moving phase. This solution for retracting the guide strips is a simple and space-saving solution for releasing the conductive segments of the pins during the transfer step.

Alternatively, the guide strips can be attached to the spindle body in order to be able to be detached from the spindle body, notably during the transfer step. In another alternative, the guide strips can experience an axial movement in an opposite direction to the transfer direction of the conductive pins.

According to one embodiment, during the transfer step, the spindle body and/or the body of the wound part experience a circumferential movement accompanying the transfer phase. This allows the conductive pins to be inserted into the body of the wound part, the conductive segments of said conductive pins are not straight, which is the case, for example, for a “twisted” wound part.

A further aim of the present invention is an assembly for transferring conductive pins, each conductive pin being formed by at least one conductive segment and being intended to be electrically connected to at least one other conductive pin via their free end in order to form an electrical winding of a wound part of a rotary electric machine extending around a first axis. According to the invention, the transfer assembly is designed to assist the implementation of the insertion method described above and comprises:
a transfer device comprising a spindle body extending around the second axis and a plurality of guide strips radially extending from the spindle body, with lateral spaces intended to house at least one conductive segment being defined between two adjacent guide strips, with at least one guide strip being movable between an engagement position, in which at least one portion of said strip extends between two conductive segments, and a disengagement position, in which said at least one portion of the strip extends away from said two conductive segments;
a base arranged to retain the body of the wound part;
a guide device arranged to guide the conductive segments of said conductive pins in a circumferential and/or radial direction.

According to one embodiment, the guide device has rods circumferentially extending between two conductive segments.

According to one embodiment, the rods experience translation movements in axial and/or radial and/or circumferential directions.

According to one embodiment, the guide device and the base form the same tool so that the body of the wound part is retained by the guide device. Alternatively, the guide device and the base form two separate tools.

According to one embodiment, the transfer assembly further comprises an axial retention support arranged to retain the conductive pins in an axial direction in order to avoid an axial movement of said pins relative to the spindle body; and/or a radial retention support arranged to retain the conductive segments of the conductive pins in a radial direction in the lateral spaces of the spindle body; and/or a blocking device arranged to block the conductive pins in a radial direction in order to avoid a radial movement of said pins relative to the body of the wound part.

For example, the axial retention support forms an axial stop for preventing an axial movement of the conductive pins opposite a direction of insertion of said pins into the body of the wound part.

For example, the retention support is arranged to block a radial movement of the conductive segments, which movement is toward the outside relative to the axis of the spindle body.

For example, the blocking device is arranged to block a radial movement of the conductive segments, which movement is toward the outside relative to the axis of the body of the wound part.

According to one embodiment, the assembly further comprises a thrust device arranged to retain the conductive pins in a radial direction and/or to exert a thrust force on said pins in a radial direction toward the outside relative to the axis of the body of the wound part. This prevents the conductive pins from coming into contact with the body of the wound part, notably with the internal end of said body, in particular the tooth roots, and thus better guarantees their insertion into said body.

According to one embodiment, the assembly further comprises a device for immobilizing at least one power supply or connection conductive pin in the spindle body, with the height of said power supply or connection conductive pin in an axial direction being different from the height of a standard conductive pin in an axial direction. This immobilization device allows the insertion method described above to be carried out only once even when the electrical winding to be inserted has different types of conductive pins. This allows the insertion method to be simplified and to be standardized irrespective of the type of conductive pins that are used.

According to one embodiment, at least one conductive pin has two conductive segments connected together by an elbow joint, with said conductive segments respectively being arranged at different distances from the axis and at a different angle. In other words, the conductive segments of the same pin are not radially aligned with each other. The conductive segments are therefore arranged in different lateral spaces of the transfer device.

The present invention will be better understood upon reading the following detailed description of non-limiting exemplary embodiments of the invention, and with reference to the appended drawings, in which:

FIG. 1 schematically and partially shows a cross-sectional view of a rotary electric machine according to an exemplary embodiment of the invention;

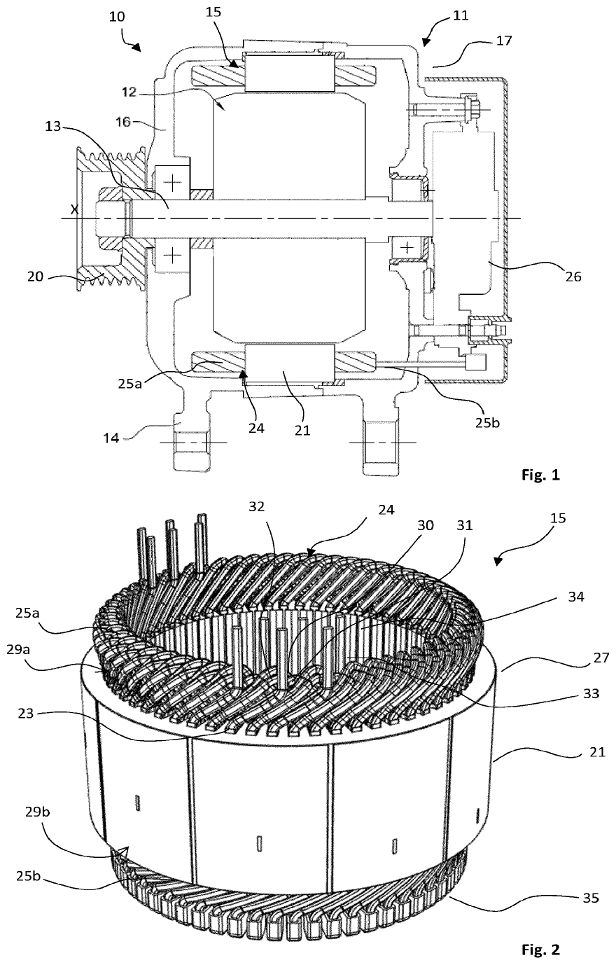

FIG. 2 schematically shows a perspective view of the stator of FIG. 1;

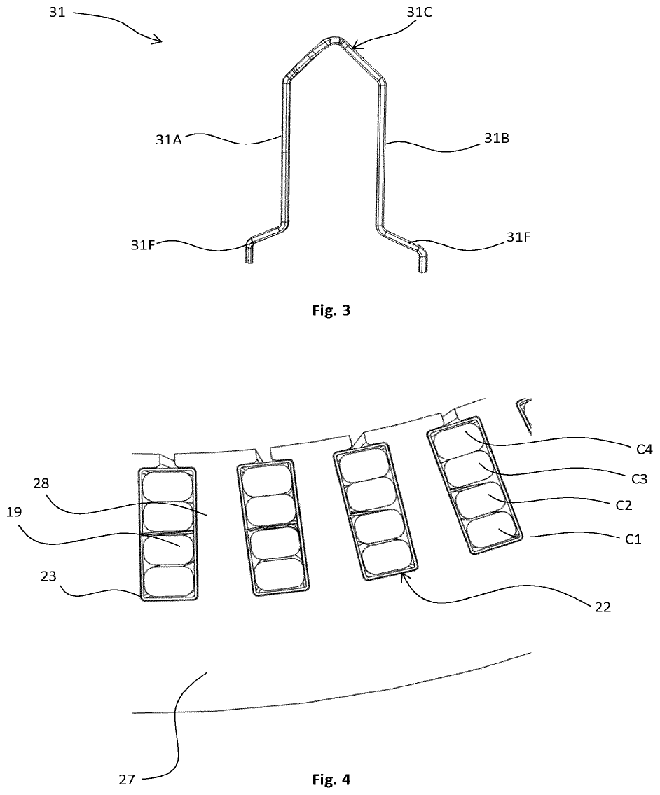

FIG. 3 schematically shows a perspective view of an example of a conductive pin of the stator of FIG. 2;

FIG. 4 schematically shows a cross-sectional view along a radial plane of part of the stator of FIG. 2;

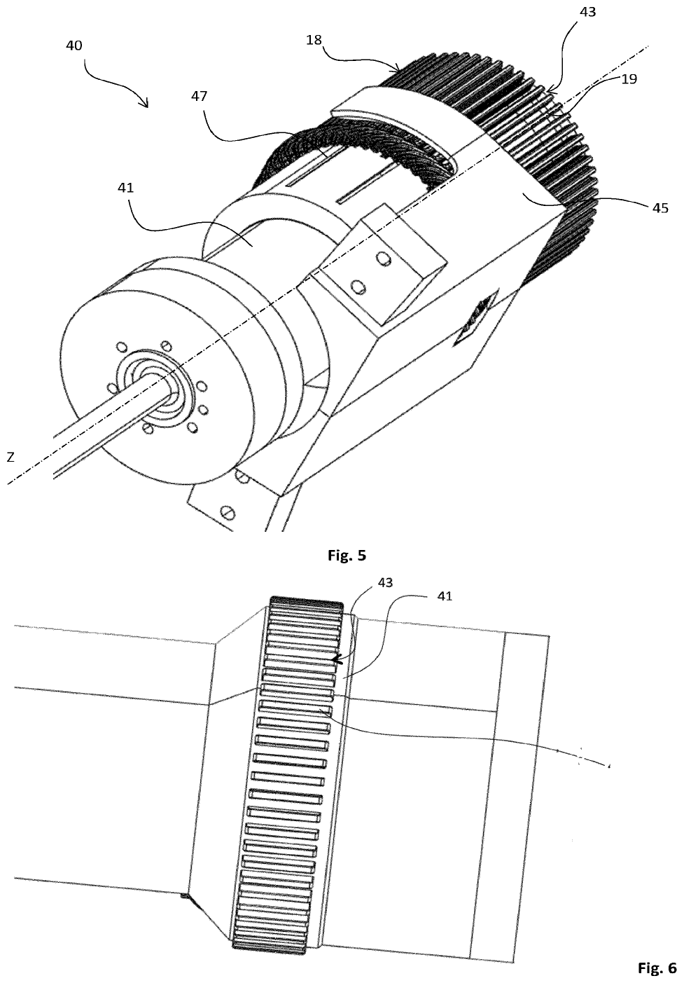

FIG. 5 schematically shows a perspective view of an example of a transfer device supporting conductive pins;

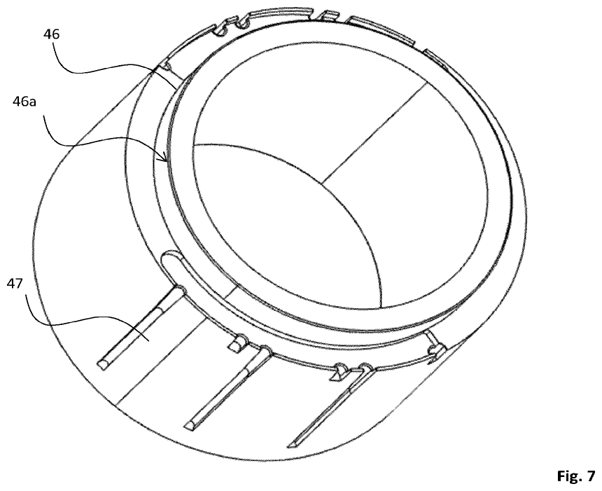

FIG. 6 schematically shows a perspective view of the spindle body of the transfer device of FIG. 5;

FIG. 7 schematically shows a perspective view of the axial retention support of the transfer device of FIG. 5;

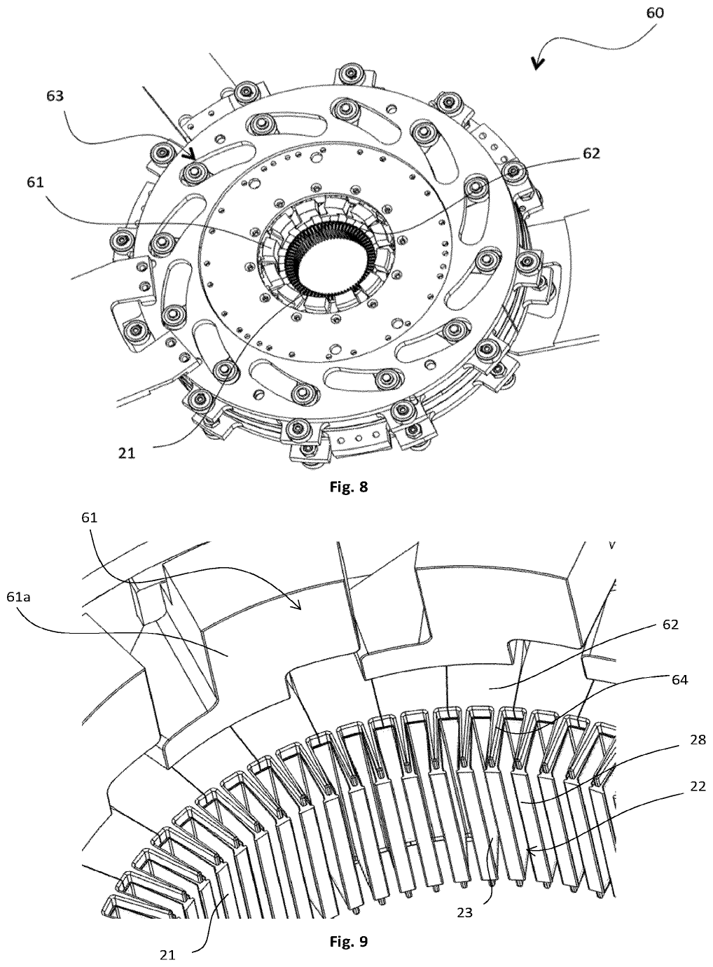

FIG. 8 schematically shows a perspective view of an example of a base provided with the guide device, into which base the body of the wound part of FIG. 2 is inserted without the conductive pins;

FIG. 9 shows an exploded view of part of the base of FIG. 8;

FIG. 10 schematically and partially shows the transfer device of FIG. 5 arranged in the base of FIG. 8 in order to carry out a step of the insertion method;

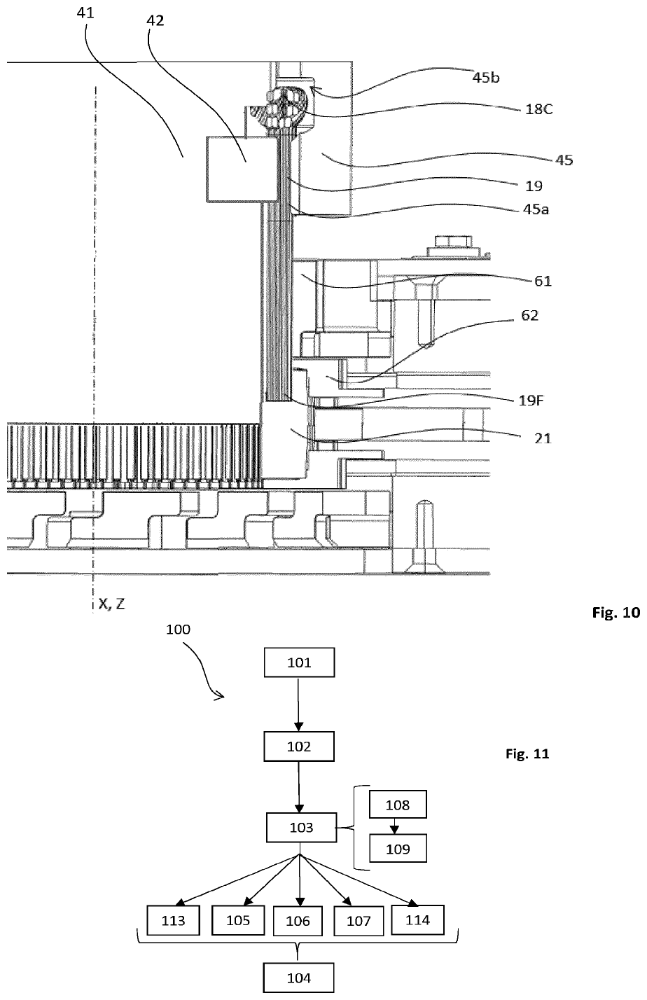

FIG. 11 shows a flowchart of an example of the insertion method.

Identical, similar or comparable elements use the same reference signs from one figure to the next. It also should be noted that the various figures are not necessarily to the same scale.

FIG. 1 shows an example of a compact and polyphase rotary electric machine 10, notably for a vehicle such as a motor vehicle or a drone. This machine 10 converts mechanical energy into electrical energy, in alternator mode, and can operate in motor mode in order to convert electrical energy into mechanical energy. This rotary electric machine 10 is, for example, an alternator, a starter-alternator, a reversible machine or an electric motor.

In this example, the machine 10 comprises a casing 11, notably formed by a first flange 16 and a second flange 17, fixed to the vehicle by fixing means 14. The inside of this casing 11 further comprises a shaft 13, a rotor 12 rigidly connected to the shaft 13 and a stator 15 surrounding the rotor 12. The rotation movement of the rotor 12 occurs about an X-axis. Throughout the remainder of the description, the axial direction corresponds to the X-axis, passing through the center of the shaft 13, whereas the radial orientations correspond to planes concurrent, and notably perpendicular, to the X-axis. For the radial directions, the term “internal” corresponds to an element oriented toward the axis, or closer to the axis compared to a second element, with the term “external” denoting remoteness from the axis. A drive component 20, such as a pulley or a sprocket, can be fixed to a front end of the shaft 13. This component allows the rotation movement to be transferred to the shaft or allows the shaft to transfer its rotation movement.

In the embodiment described in the remainder of the description, the wound part corresponds to the stator 15 of the rotary electric machine. However, using a rotor as a wound part will not depart from the scope of the invention.

In this exemplary embodiment, the stator 15 comprises a body 21 of the wound part formed by a lamination stack provided with slots 22, equipped with a slot insulator 23 for mounting an electrical winding 24. The winding passes through the slots of the body 21 and forms a front winding overhang 25a and a rear winding overhang 25b on either side of the body of the wound part. Furthermore, the winding 24 is formed by one or more phases comprising at least one electrical conductor and is electrically connected to an electronic assembly 26. The electronic assembly 26, which in this case is mounted on the casing 11, comprises at least one electronic power module allowing at least one phase of the winding 24 to be controlled. The power module forms a voltage converter notably forming a voltage bridge rectifier for converting the generated AC voltage into a DC voltage, and vice versa. Alternatively, the electronic assembly could be remote from the machine.

FIG. 2 shows the stator 15 in greater detail. The body 21 of the wound part is formed by an annular shaped yoke 27 around the X-axis and by a plurality of teeth 28 radially extending toward the center of the stator from the yoke, and in particular in this case from a lateral face forming an internal wall of the yoke 27. The teeth 28 are evenly angularly distributed around the periphery of the yoke, with successive spaces provided between two adjacent teeth so as to define the slots 22. In the axial direction, the slots 22 are open on a first axial end face 29a and a second axial end face 29b of the body 21 of the wound part. In other words, the slots axially pass through the body and emerge on the two opposite axial end faces of the stator. The term “axial end faces” is understood to mean faces perpendicular or substantially perpendicular to the axis of rotation X of the stator.

The winding 24 is formed from a plurality of conductive pins 18, each having at least one conductive segment 19, electrically connected together in order to form electrical paths forming the phases of the winding. In the example of FIG. 2, each phase comprises a plurality of conductive pins 18, including a plurality of first standard pins 31, a plurality of second standard pins 30, a connection pin 32 and two power supply pins 33, 34. Alternatively, each phase can be formed differently, thus, changing the composition of the type of conductive pin forming a phase, for example, by removing the connection pin or by having a different number of standard pin types, will not be departing from the scope of the invention.

As illustrated in FIG. 3, a standard conductive pin 30, 31 is formed by two conductive segments 31A, 31B axially extending in the slots 22 and which to this end are substantially parallel to each other. Said conductive segments are connected together by means of an elbow joint 31C, which is also conductive so as to form electrical continuity. The conductive segments 31A, 31B of the same pin 30, 31 are disposed in two slots that are distinct from each other. The conductive segments are each connected to another conductive pin via their respective free ends 31F. These electrical connections between the conductive pins are produced by soldering, for example. The free ends 31F and the elbow joint 31C axially extend outside the slots so as to form the overhangs 25a, 25b. The power supply pins 33, 34 are each formed by a single conductive segment axially extending in the slots 22. The shape of the connection pin 32 can be similar to the shape of the standard pins or of the power supply pins. The height of at least one power supply pin 33, 34 or of at least one connection pin 32, in an axial direction, can differ from the height of a standard pin 30, 31.

As shown in FIG. 4, the various conductive segments 19 disposed in the same slot 22 are superposed in order to form a stack of N layers Ci, with it being understood that these N layers are present in each of the slots so that substantially mutually coaxial annular circles are formed on the periphery of the stator. In this exemplary embodiment, there are four of these layers, numbered from C1 to C4, according to their stacking order in the slots 22. The first layer C1 corresponds to the external layer, the second layer C2 corresponds to an external central layer directly adjacent to the first layer C1, the third layer C3 corresponds to the internal central layer directly adjacent to the second layer C2 and the fourth layer C4 corresponds to the internal layer. The first layer C1 is thus occupied by the conductive segment closest to the yoke 27 and the layer C4 is thus occupied by the conductive segment closest to the X-axis. Of course, the invention is not limited to this single embodiment so that a greater or lesser number of conductive segments can be stacked in each slot, for example, 2, 6, 8 or 10 conductors. For example, a layer is formed by a single conductive segment. Thus, each slot 22 comprises N conductive segments radially aligned relative to each other on a single line and each forming a layer Ci. In the illustrated example, the conductive segments each have a substantially rectangular section making them easier to stack in the slot.

A method 100 for inserting conductive pins 18 will now be described with reference to FIGS. 5 to 11, which method allows the conductive pins to be inserted from a transfer device 40 to the slots 22 of the body 21 of the wound part. FIG. 5 shows an example of a transfer device 40, in which the conductive pins 18 are arranged before they are transferred into the body 21 of the wound part. The transfer device 40 comprises a spindle body 41 of generally cylindrical shape extending around a second Z-axis, and comprises a plurality of guide strips 42 radially extending from the spindle body 41. Two adjacent guide strips define a lateral space 43, in which at least one conductive segment 19 of a conductive pin can be housed, and notably several conductive segments, four in this example. FIG. 6 shows the spindle body 41, the guide strips 42 and the lateral spaces 43 without the conductive pins 18.

During this insertion method 100, the conductive pins 18 assume an intermediate shape, i.e., they assume a shape that is not the final shape of the conductive pins for forming the electrical winding 24. During this insertion method, each pin 18 has undergone a prior shaping step, during which an elbow joint 18C is formed, notably by means of a first folding phase and then of a second twisting phase, allowing the conductive segments 19 of the same conductive pin to be circumferentially shifted. The twisting phase is preferably a single twisting phase carried out individually for each conductive pin 18. During said method, the conductive segments 19 axially extend up to their free end 19F.

The insertion method 100 has a first preparation step 101, in which the conductive pins 18 are loaded into the spindle body 41 of the transfer device 40. This preparation step 101 can be carried out manually, with an operator manually positioning the conductive pins in the lateral spaces one at a time, or can be carried out automatically. Examples of a method describing this preparation step 101 in detail, when it is carried out automatically, are available, for example, in the French patent applications respectively filed under numbers 2108842, 2108845 and 2108847. Each of these applications describes an automatic method for loading the conductive pins 18 into the transfer device 40. The content of each of these applications is included in this description for reference purposes. The particular feature of each of these methods is that the conductive pins 18 are sequentially arranged in the lateral spaces 43, i.e., during several successive insertion steps.

The preparation step 101 can be entirely carried out by one of the manual or automatic methods described above or by combining several of said methods. For example, the standard pins 30, 31 can be loaded by means of one of the automatic methods and the connection 32 and/or power supply 33, 34 pins can be loaded by means of the manual method. Alternatively, it is also possible to load only the standard pins 30, 31 during the preparation step 101, with the connection 32 and/or power supply 33, 34 pins being able to be directly manually or automatically loaded in the body 21 of the wound part once the standard pins 30, 31 are inserted into said body 21.

After this preparation step 101, the conductive pins 18 are arranged in the spindle body 41 so that the conductive segments 19 are at least partially housed in the lateral spaces 43. More specifically in this example, and as shown in FIG. 10, the conductive segments 19 are housed in the lateral spaces 43 so that each free end 19F axially protrudes from the lateral space. In other words, the height of each guide strip 42 in an axial direction is less than an axial height of the conductive segments 19. Alternatively, the height of each guide strip 42 can be equal to or greater than the axial height of the conductive segments 19.

A transfer assembly for implementing the insertion method 100 comprises the transfer device 40 and a base 60, illustrated in FIG. 8. The base 60 allows the body 21 of the wound part to be retained, notably in all directions, during the insertion method 100.

The insertion method 100 has a second step 102 of positioning the spindle body 41 of the transfer device 40 relative to the body 21 of the wound part so that at least one portion of each lateral space 43 is axially aligned with at least one portion of a slot 22. Alternatively, an angular offset can be contemplated for compensating for any assembly clearances. The spindle body 41 is also positioned so that the free ends 19F of the conductive segments extend facing the slots 22. During this example of a positioning step 102, the spindle body and the body of the wound part are positioned so that their respective X- and Z-axes are arranged so as to be parallel and, notably, so as to be mutually coincident.

Prior to said positioning step 102, the slot insulators 23 are positioned in the respective slots 22 of the body 21.

The insertion method 100 has a third guide step 103, in which a guide device 62 guides the conductive segments 19 in order to facilitate their insertion into the slots. The guide device 62 in this case has a plurality of rods 64, each rod 64 can experience a translation movement in a radial and/or axial and/or circumferential direction between a guide position, in which the rod is arranged so as to be axially aligned with an associated tooth 28, and a rest position, in which the rod is radially set back relative to said tooth. The translation movement of the rods 64 can be achieved by means of a cam system. The shape of the rods 64 can include chamfers for facilitating guidance.

For example, the guide step 103 comprises a first insertion phase 108, in which the rods 64 of the guide device 62 are inserted between the conductive segments 19 in order to reach their respective insertion position. This insertion position is preferably close to the guide strips in order to facilitate the radial insertion of said rods between the conductors. The guide step 103 comprises a second smoothing phase 109, at the end of which the rods 64 are positioned in their position for guiding said conductive segments 19. The smoothing phase 109 can include axial translation movements of the rods 64 and/or of the spindle body 41 in order to transition from the insertion position to the guide position. In the guide position, the rods 64 are arranged in the vicinity of the ends 19F of the conductive segments in order to achieve more precise guidance of said segments. The smoothing phase 109 can also include a circumferential movement of the rods 64 and/or of the spindle body 41 in order to better position the conductive segments 19 opposite the slots 22.

The insertion method 100 comprises a fourth transfer step 104, in which the conductive segments 19 are inserted into the slots 22 up to a final axial position of each conductive segment in the body 21 of the wound part. This final position is notably reached when part of each elbow joint 18C is in axial abutment against the body 21 of the wound part or the insulator 23 covering said body 21.

The transfer step 104 comprises a transfer phase 114, which is carried out by moving the conductive pins 18 and/or the body 21 in an axial direction. Preferably this movement is only an axial movement. The arrangement of the conductive pins 18 in the spindle body 41 in relation to each other corresponds to the arrangement of said pins 18 in the body 21 of the wound part. The arrangement of said pins in relation to each other is not modified during the transfer step. In other words, the arrangement of the conductive segments 19 in the lateral spaces 43 corresponds to the arrangement of said segments 19 in the slots 22 of the body 21 of the wound part. Thus, the transfer step corresponds to a translation movement of the pins in an axial direction from the spindle body 41 to the body 21 of the wound part. Preferably, the rods 64 of the guide device 62 remain in their guide position during the transfer step 104.

Alternatively, the transfer phase can comprise a movement in a circumferential direction in addition to the movement in an axial direction. This can allow pins to be inserted with conductive segments that are not straight, i.e., extend in a direction that is circumferentially inclined relative to the Z-axis.

As can be seen in the example of FIG. 10, the body 21 of the wound part and the spindle body 41 have mutually matching shapes so that, during the transfer step 104, the spindle body is inserted into the central space defined by the body of the wound part. The external diameter of the spindle body 41 in this case is less than the internal diameter of the body 21 of the wound part.

The transfer step 104 also comprises a movement phase 113, in which the guide strips 42 are removed as the axial translation movement progresses so as to allow the spindle body 41 to be inserted into the body 21 of the wound part. Each strip 42 is thus movable between an engagement position, in which a portion of the strip extends between two conductive segments 19, and a disengagement position, in which said portion of the strip does not extend between said conductive segments. For example, each guide strip 42 can have different radial positions relative to said body 41. For example, each guide strip is arranged in the engagement position so as to circumferentially extend between at least two conductive segments 19, and is arranged in the disengagement position so as to be housed in a groove formed in the spindle body 41, so that the circumferential space between said two conductive segments is kept free. Alternatively, the strips can experience an axial translation movement between the engagement position and the disengagement position. Still alternatively, the strips can be detachably mounted so as to be completely detached from the spindle body 41 in the disengagement position.

The spindle body 41 can comprise a protuberance at least partially inserted into a slot 22, so as to circumferentially align the body 21 of the wound part relative to the spindle body. This allows the insertion of the pins 18 to be oriented in said body 21 so as to thus create an index. The protuberance can extend radially so as to be inserted into the internal opening of a slot 22, i.e., between two tooth roots.

The transfer device 40 can comprise a radial retention support 45, shown in FIGS. 5 and 10. The radial retention support 45 is arranged to retain the conductive segments 19 of the conductive pins 18 in the lateral spaces 43 in a radial direction. The retention support is positioned around the outer circumference of the spindle body 41 provided with said pins 18. Preferably, the retention support 45 can completely surround said body 41. The retention support 45 can have a plurality of portions arranged adjacently so as to surround said body 41. This allows the positioning of said support to be simplified.

The radial retention support 45 can have an internal surface 45a extending around at least one portion of the conductive segments 19 so as to block their radial movement toward the outside relative to the Z-axis. The internal surface 45a can form a smooth surface. The radial retention support 45 has a groove 45b arranged to at least partially house the elbow joints 18C. This allows the internal surface 45a to be brought as close as possible to the conductive segments.

The radial retention support 45 is notably positioned around the spindle body 41 provided with the conductive pins 18 during the preparation step 101. The transfer step 104 comprises a phase 105 of removing the radial retention support 45. The removal phase 105 can comprise a first phase, in which the radial retention support 45 is axially offset in an opposite direction to the direction for transferring the conductive pins 18, and then a second removal phase, in which said support 45 is remote from the conductive pins 18 so that they can no longer be retained.

The transfer device 40 can comprise an axial retention support 46. The axial retention support 46 is arranged to retain the conductive pins 18 in an axial direction in order to prevent an axial movement of said pins relative to the spindle body 41. In the embodiment shown in FIG. 7, the axial retention support 46 has a cylindrical shape, an axial end of which is arranged to come into abutment on a summit of the elbow joints 18C. For example, the axial end comprises a groove 46a for at least partially housing said elbow joints 18C, while forming the axial stop. The groove 46a can have different depths in order to adapt to the various axial heights of the pins and notably of the elbow joints of the standard pins 30, 31 and of the connection pins 32.

The axial retention support 46 is notably positioned above the spindle body 41 provided with the conductive pins 18 during the preparation step 101. The transfer step 104 comprises a phase 106 involving the axial retention support 46 retaining the conductive pins in an axial direction in order to prevent an axial movement of said pins relative to the spindle body 41. The retention phase 106 is notably carried out throughout the transfer step 104.

The transfer device 40 can comprise a thrust device, not shown in the figures. The thrust device is arranged to push, in a radial direction outside the conductive segments 19, the conductive pins 18 housed in the lateral spaces 43. The thrust device can have an external surface extending inside a diameter formed by the conductive segments 19, so as to exert a pressure force on said segments in an external radial direction. This prevents said segments from coming into contact with the body 21 of the wound part and notably with the tooth roots of said body during the transfer phase 114.

The transfer device 40 can comprise an immobilization device 47 allowing at least one power supply pin 33, 34 and/or at least one connection pin 32 to be retained in the spindle body 41. The immobilization device 47 notably allows said pins to be retained in the radial and axial directions. The immobilization device 47 in this case allows a phase 107 of blocking at least one power supply pin 33, 34 to be carried out during the transfer 104 and insertion 103 steps.

In this exemplary embodiment, the immobilization device 47 is formed by a groove, into which a power supply pin 33, 34 is inserted. The connection pin 32 in this case is retained in the same manner as the standard pins 30, 31, via the guide strips 42. Alternatively, the immobilization device 47 can be formed by walls surrounding the pin to be retained or by a snap-fitting system.

In the exemplary embodiment illustrated in FIG. 7, the axial retention device 46 and the immobilization device 47 are formed in the same tool. Alternatively, the axial retention device 46 and the immobilization device 47 could be formed in two separate tools.

FIGS. 8 and 9 illustrate an example of a base 60 in greater detail. In this example, the base comprises the guide device 62. Thus, the body 21 of the wound part is axially retained by the guide device 62. The guide step 103 is thus mainly carried out by movements of the spindle body 41. Alternatively, the base 60 and the guide device 62 can be separate tools. In this alternative, the base 60 can comprise a support for retaining the body 21 of the wound part. Said support can have a cylindrical shape matching the shape of said body 21.

During the transfer step 104, the guide device 62 is mounted on the body 21 of the wound part and notably on one of the axial end faces 29a, 29b of said body 21. For example, each rod 64 is mounted on an axial end surface of a tooth 28 of the body 21 of the wound part. The guide device 62 can be mounted in contact with said body 21 or slightly offset in an axial direction.

In this example, the base 60 comprises a blocking device 61 arranged to retain the conductive pins 18 in the slots 22 of the body 21 of the wound part in a radial direction toward the outside. The blocking device 61 is notably axially offset relative to the body 21 of the wound part, so as to be arranged between the body 21 of the wound part and the spindle body 41 before the transfer phase 114. The blocking device 61 is notably arranged along an outer circumference formed by the set of conductive pins 18. The blocking device 61 allows the radial retention support 45 to be replaced in order to continue retaining said pins 18 in a radial direction as close as possible to the body 21 of the wound part during the transfer phase 114. The guide device 62 in this case is axially arranged between the blocking device 61 and the body 21 of the wound part.

In this example, the blocking device 61 has several blocking portions 61a arranged adjacently in order to surround the set of conductive pins 18. For example, each blocking portion 61a can have a first blocking position, in which the conductive pins 18 are retained, and a second rest position, in which said blocking portion extends away from said pins. The blocking portions 61a can experience a translation movement in a radial direction between the blocking position and the rest position. As can be seen in FIG. 9, the blocking portions 61a can have mutually matching shapes in order to allow them to be circumferentially interleaved in their blocking position. As can be seen in FIG. 8, the radial translation movement of the blocking device 61 can be carried out by means of a cam system 63.

The base 60 can comprise two guide devices 62, with each of them being axially positioned on either side of the body 21 of the wound part. Similarly, the base 60 can comprise two blocking devices 61, with each of them being axially positioned on either side of the body 21 of the wound part. This allows the free ends 19F of the conductive segments that pass through the body of the wound part to be guided and retained during the transfer step 104.

Once the transfer step 104 is complete, the method can comprise a step of twisting the free ends 19F of the conductive pins so that they can assume their final position with a view to making the electrical connections between said pins, so as to form the electrical winding 24.

The present invention is particularly applicable in the field of alternators, starter-alternators, electric motors, or even reversible machines, but it could equally be applied to any type of rotary machine. Of course, the above description has been provided solely by way of an example and does not limit the field of the present invention, and replacing the various elements with any other equivalents would not be departing from the scope of the present invention. For example, adapting the insertion method and the transfer assembly described above for a rotary electric machine, the stator of which is radially positioned inside the rotor, will not depart from the scope of the invention.

1. A method for inserting conductive pins from a transfer device to a body of a wound part, each conductive pin being formed by at least one conductive segment and being intended to be electrically connected to at least one other conductive pin via their free end in order to form an electrical winding of a wound part of a rotary electric machine extending around a first axis, the transfer device comprising a spindle body extending around a second axis and a plurality of guide strips radially extending from the spindle body, with lateral spaces intended to house at least one conductive segment being defined between two adjacent guide strips, the wound part comprising a cylindrical shaped body and a plurality of teeth extending from said body of the wound part so as to define slots between two adjacent teeth, which slots are intended to house at least one conductive segment, the insertion method being wherein it comprises:
a preparation step, in which the conductive pins are at least partially arranged in the lateral spaces of the spindle body of the transfer device;
a step of positioning the spindle body of the transfer device relative to the body of the wound part so that they are axially positioned one above the other;
a guide step, in which a guide device is arranged to guide the conductive segments of said conductive pins in a circumferential and/or radial direction; and
a transfer step comprising a transfer phase, in which the conductive segments are inserted into the corresponding slots in an axial direction, and a phase of moving at least one guide strip between an engagement position, in which at least one portion of said strip extends between two conductive segments, and a disengagement position, in which said at least one portion of the strip extends away from said two conductive segments.

2. The insertion method as claimed in claim 1, wherein, during the preparation step, the conductive pins are sequentially arranged in the lateral spaces.

3. The insertion method as claimed in claim 1, wherein, during the positioning step, the spindle body and the body of the wound part are arranged such that each lateral space is at least partially axially aligned with a corresponding slot of the body of the wound part.

4. The insertion method as claimed in claim 1, wherein the guide device comprises rods radially inserted between the conductive segments, with the guide step being carried out by moving said rods and/or the spindle body in a circumferential and/or radial direction.

5. The insertion method as claimed in claim 1, wherein the guide step comprises a phase of inserting at least one portion of the guide device between conductive segments in an insertion position, and a smoothing phase, in which the guide device and/or the transfer device is/are axially moved between the insertion position and a guide position, in which said portion of the guide device is arranged closer to the ends of said conductive segments relative to the insertion position.

6. The insertion method as claimed in claim 1, wherein the body of the wound part has an annular shape extending around the first axis and the spindle body has a cylindrical shape extending around the second axis matching said annular shape such that, during the transfer step, the spindle body is inserted into the body of the wound part.

7. The insertion method as claimed in claim 1, wherein the spindle body further comprises at least one protuberance that at least partially inserts into a slot so as to circumferentially align the body of the wound part relative to the spindle body.

8. The insertion method as claimed in claim 1, wherein the transfer step further comprises a phase of removing a radial retention support that is arranged to retain the conductive segments of the conductive pins in the lateral spaces of the spindle body in a radial direction.

9. The insertion method as claimed in claim 1, wherein the transfer step further comprises a phase of retaining the conductive pins in an axial direction, using an axial retention support, so as to prevent axial movement of said pins relative to the spindle body.

10. The insertion method as claimed in claim 1, wherein the transfer step further comprises a phase of blocking the conductive pins in an axial direction, using a blocking device, so as to prevent a radial movement of said pins relative to the body of the wound part.

11. The insertion method as claimed in claim 1, wherein the guide strips are retractable so as to be able to be respectively housed in corresponding grooves produced in the spindle body, during the moving phase.

12. The insertion method as claimed in claim 1, wherein, during the transfer step, the spindle body and/or the body of the wound part experience a circumferential movement accompanying the transfer phase.

13. An assembly for transferring conductive pins, each conductive pin being formed by at least one conductive segment and being intended to be electrically connected to at least one other conductive pin via their free end in order to form an electrical winding of a wound part of a rotary electric machine extending around a first axis, the transfer assembly being designed to assist the implementation of the insertion method as claimed in claim 1, the transfer assembly wherein it comprises:
a transfer device comprising a spindle body extending around a second axis and a plurality of guide strips radially extending from the spindle body, with lateral spaces intended to house at least one conductive segment being defined between two adjacent guide strips, with at least one guide strip being movable between an engagement position, in which at least one portion of said strip extends between two conductive segments, and a disengagement position, in which said at least one portion of the strip extends away from said two conductive segments;
a base arranged to retain the body of the wound part;
a guide device arranged to guide the conductive segments of said conductive pins in a circumferential and/or radial direction.

14. The transfer assembly as claimed in claim 13, wherein the guide device has rods circumferentially extending between two conductive segments.

15. The transfer assembly as claimed in claim 13, wherein the assembly comprises a device for immobilizing at least one power supply or connection conductive pin in the spindle body, with the height of said power supply or connection conductive pin in an axial direction being different from the height of a standard conductive pin in an axial direction.

16. The insertion method as claimed in claim 2, wherein, during the positioning step, the spindle body and the body of the wound part are arranged such that each lateral space is at least partially axially aligned with a corresponding slot of the body of the wound part.

17. The insertion method as claimed in claim 2, wherein the guide device comprises rods radially inserted between the conductive segments, with the guide step being carried out by moving said rods and/or the spindle body in a circumferential and/or radial direction.

18. The insertion method as claimed in claim 2, wherein the guide step comprises a phase of inserting at least one portion of the guide device between conductive segments in an insertion position, and a smoothing phase, in which the guide device and/or the transfer device is/are axially moved between the insertion position and a guide position, in which said portion of the guide device is arranged closer to the ends of said conductive segments relative to the insertion position.

19. The insertion method as claimed in claim 2, wherein the body of the wound part has an annular shape extending around the first axis and the spindle body has a cylindrical shape extending around the second axis matching said annular shape such that, during the transfer step, the spindle body is inserted into the body of the wound part.

20. The insertion method as claimed in claim 2, wherein the spindle body further comprises at least one protuberance that at least partially inserts into a slot so as to circumferentially align the body of the wound part relative to the spindle body.
